(19) United States
(12) Patent Application Publication
(10) Pub. No.: US 2026/0035567 A1
(43) Pub. Date: Feb. 5, 2026

(54) COLORANTS WITH LOW LEVELS OF MANGANESE OXIDE

(71) Applicant: BASF SE, Ludwigshafen am Rhein (DE)

(72) Inventors: Christopher J. VALOVIC, Charlotte, NC (US); Nicolas A. FOLEY, Charlotte, NC (US); Xin LI, Charlotte, NC (US); Alan H. KOHEN, Charlotte, NC (US); Robert Mario PALOMINO, Kendall Park, NJ (US); Brian Shane CARPENTER, Charlotte, NC (US)

(21) Appl. No.: 19/100,953

(22) PCT Filed: Aug. 4, 2023
(86) PCT No.: PCT/US2023/029510

§ 371 Date: Feb. 4, 2025

Related U.S. Application Data
(60) Provisional application No. 63/395,350, filed on Aug. 5, 2022.
(60) Provisional application No. 63/395,351, filed on Aug. 5, 2022.

(51) Int. Cl. C09C 1/24; C08K 3/04; C08K 3/22; C09C 1/48; C09D 7/61; C09D 7/80; C09D 179/06

(52) U.S. Cl. CPC C09C 1/24; C08K 3/04; C08K 3/22; C09C 1/48; C09D 7/61; C09D 7/80; C09D 179/06; C01P 2006/62; C01P 2006/63; C01P 2006/64

(57) ABSTRACT

The present disclosure provides a coating composition comprising a pigment in the color space L* from +26.00 to +34.00; a* from −1.00 to +3.00; and b* from +1.00 to +5.00, as measured using the CIEL*a*b*DE* system, where the amount of reactive manganese oxide is less than 0.1 atomic percent (At %) of the pigment. The present disclosure further provides a method of making the coating composition.

### FIELD OF THE DISCLOSURE

The present disclosure relates to colorants with low levels of manganese oxide for use in paints or coatings.

### BACKGROUND OF THE DISCLOSURE

Many paints are produced by mixing at least one colorant with a paint base. The colorant is often composed of one or more pigments and a number of other compounds. Paint bases or coating compositions in general may involve crosslinking chemistry in order to provide coatings with improved properties, such as durability, moisture resistance, and substrate adhesion. For example, a paint base may include two cross-linkable compounds that coalesce and crosslink at ambient conditions as the solvent evaporates. However, the combination of certain colorants and paint bases may result in gas generation or off-gassing from reactions between components of the colorant and the base. This is particularly the case in the color space of raw umber. This gas generation may occur over a period of days to months and may result in pressure buildup within a paint can. The pressure may cause paint to splash out of the can upon opening, or may cause the can to burst open. What is needed is an improvement over the foregoing.

### SUMMARY

It was surprisingly found that utilizing pigments with small amounts of manganese oxide, in particular small amounts of reactive manganese oxide, allowed for creation of pigments within the raw umber color space which did not have the known problems with gas generation. In contrast, raw umber which is generally available typically has a variety of manganese oxide species, often comprising at least 3% of the pigment. The following are embodiments of the invention:

A first embodiment is a pigment, comprising
sienna and/or raw umber pigment,
wherein the color space of a white coating composition with a 2 oz/gallon volumetric colorant loading has the following properties:
(i) L* from +26.00 to +34.00;
   a* from −1.00 to +3.00; and
   b* from +1.00 to +5.00, as measured using the CIEL*a*b*DE* system;
the color space of a medium coating composition with a 10 oz/gallon volumetric colorant loading has the following properties:
(ii) L* from +55.00 to +65.00;
   a* from 0.00 to +4.50; and
   b* from +6.00 to +9.00, as measured using the CIEL*a*b*DE* system;
and the color space of a neutral coating composition with a 14 oz/gallon volumetric colorant loading comprising said colorant has the following properties:
(iii) L* from +75.00 to +85.00;
   a* from −1.00 to +3.00; and
   b* from +3.00 to +7.00, as measured using the CIEL*a*b*DE* system;
wherein an amount of manganese (III) and (IV) oxides in the pigment is less than 0.1 atomic percent (At %) of the pigment.

A second embodiment is the pigment of the first embodiment, wherein the pigment comprises sienna.

A third embodiment is the pigment of the first embodiment, wherein the pigment further comprises carbon black.

A fourth embodiment is a colorant comprising: the pigment of the first embodiment; one or more extenders; and one or more additives.

A fifth embodiment is a paint comprising:
a paint base; and
a colorant comprising:
a pigment comprising sienna and/or raw umber pigment, wherein the color space of a white coating composition with a 2 oz/gallon volumetric colorant loading has the following properties:
(i) L* from +26.00 to +34.00;
a* from −1.00 to +3.00; and
b* from +1.00 to +5.00, as measured using the CIEL*a*b*DE* system;
the color space of a medium coating composition with a 10 oz/gallon volumetric colorant loading has the following properties:
(ii) L* from +55.00 to +65.00;
a* from 0.00 to +4.50; and
b* from +6.00 to +9.00, as measured using the CIEL*a*b*DE* system;
and the color space of a neutral coating composition with a 14 oz/gallon volumetric colorant loading comprising said colorant has the following properties:
(iii) L* from +75.00 to +85.00;
a* from −1.00 to +3.00; and
b* from +3.00 to +7.00, as measured using the CIEL*a*b*DE* system;
wherein an amount of manganese (III) and (IV) oxides in the pigment is less than 0.1 atomic percent (At %) of the pigment.

A sixth embodiment is a coating composition comprising:
a first crosslinking agent comprising an acrylamide;
a second crosslinking agent comprising a hydrazide; and
a colorant, comprising:
   a pigment; and
   one or more additives;
wherein the color space of a white coating composition with a 2 oz/gallon volumetric colorant loading has the following properties:
(i) L* from +26.00 to +34.00;
   a* from −1.00 to +3.00; and
   b* from +1.00 to +5.00, as measured using the CIEL*a*b*DE* system;
the color space of a medium coating composition with a 10 oz/gallon volumetric colorant loading has the following properties:
(ii) L* from +55.00 to +65.00;
   a* from 0.00 to +4.50; and
   b* from +6.00 to +9.00, as measured using the CIEL*a*b*DE* system;
and the color space of a neutral coating composition with a 14 oz/gallon volumetric colorant loading comprising said colorant has the following properties:
(iii) L* from +75.00 to +85.00;
   a* from −1.00 to +3.00; and
   b* from +3.00 to +7.00, as measured using the CIEL*a*b*DE* system;
wherein an amount of manganese (III) and (IV) oxides in the pigment is less than 0.1 atomic percent (At %) of the pigment.

A seventh embodiment is the coating composition of the first embodiment, wherein the colorant comprises sienna.

An eighth embodiment is the coating composition of the first embodiment, wherein the colorant further comprises carbon black.

A ninth embodiment is the coating composition of the first embodiment, wherein the reactive manganese oxide comprises at least one of manganese (III) oxide and manganese (IV) oxide.

A tenth embodiment is the coating composition of the first embodiment, wherein the first crosslinking agent comprises diacetone acrylamide (DAAM).

An eleventh embodiment is the coating composition of the first embodiment, wherein the second crosslinking agent comprises adipic acid dihydrazide (ADH).

A twelfth embodiment is the coating composition of the first embodiment, wherein the composition with 5% headspace generates less than 2 psi pressure over a period of 30 days at a temperature of 72° F.

A thirteenth embodiment is a method of producing a paint comprising:
combining a first crosslinking agent comprising an acrylamide, a second crosslinking agent comprising a hydrazide, and a solvent to produce a paint base;
combining a pigment and at least one additive to produce a colorant;
adding at least one colorant to the paint base; and
mixing the colorant and the paint base to form a paint, wherein the paint comprises reactive manganese oxide in an amount of less than 0.1 atomic percent (At %) of the pigment; and
wherein the color space of a white coating composition with a 2 oz/gallon volumetric colorant loading has the following properties:
(i) L* from +26.00 to +34.00;
   a* from −1.00 to +3.00; and
   b* from +1.00 to +5.00, as measured using the CIEL*a*b*DE* system;
the color space of a medium coating composition with a 10 oz/gallon volumetric colorant loading has the following properties:
(ii) L* from +55.00 to +65.00;
   a* from 0.00 to +4.50; and
   b* from +6.00 to +9.00, as measured using the CIEL*a*b*DE* system;
and the color space of a neutral coating composition with a 14 oz/gallon volumetric colorant loading comprising said colorant has the following properties:
(iii) L* from +75.00 to +85.00;
   a* from −1.00 to +3.00; and
   b* from +3.00 to +7.00, as measured using the CIEL*a*b*DE* system;
wherein an amount of manganese (III) and (IV) oxides in the pigment is less than 0.1 atomic percent (At %) of the pigment.

A fourteenth embodiment is the method of the thirteenth embodiment, wherein the at least one colorant comprises sienna.

A fifteenth embodiment is the method of the thirteenth embodiment, wherein the at least one colorant further comprises carbon black.

A sixteenth embodiment is the method of the thirteenth embodiment, further comprising the steps of sealing the paint within a container, and storing the paint for a period of 30 days at a temperature of 72° F., wherein during the storing step the paint produces less than 2 psi pressure within the container.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a flowchart for a method of making a paint.

FIG. 2 shows results of a long term gas generation experiment, as described in Example 2.

FIG. 3 shows results of a long term gas generation experiment, as described in Example 2.

FIG. 4 shows results of a long term gas generation experiment, as described in Example 2.

FIG. 5 shows results of a long term gas generation experiment, as described in Example 2.

FIG. 6 shows results of a long term gas generation experiment, as described in Example 2.

FIG. 7 shows results of a long term gas generation experiment, as described in FIG. 8 shows results of a long term gas generation experiment, as described in Example 2.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

The present disclosure provides coatings, paints, and colorants in the raw umber color space with low levels of manganese oxides. These coatings, paints, and colorants can be formulated into the same color space as raw umber, but with reduced off-gas. The colorants may comprise a pigment with low levels of reactive manganese oxide compounds comprising MnO₂, Mn₂O₃, and MnOOH (e.g. less than 1.5 atomic percent). Specifically, the pigment may comprise a blend of sienna and carbon black, as further defined below. The colorants may be mixed with a base composition (e.g. a paint or coating base) to form a paint or coating. The base composition may comprise a first crosslinking agent and a second crosslinking agent, such that the base composition and colorant may cure and form a coating layer over a substrate. The combination of a base composition and a colorant with a low level of manganese oxide may result in a reduction in gas generation or off-gassing.

### I. Definitions

For purposes of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” For example, generated pressures, weight percentages of components, or amounts of components added should be construed as being modified by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. When ranges are listed in the specification and in the claims, it is understood that all the numbers including decimals within the range are included whether specifically disclosed. Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. For example, if the range is from 1 to 10, the range would include every number within the range, such as 1; 1.1; 1.2; 1.3; 1.4; 1.5; 1.6; 1.7; 1.8; 1.9; 2; 2.1; 2.2; 2.3; 2.4; 2.5; 2.6; 2.7; 2.8; 2.9; 3; 3.1; 3.2; 3.3; 3.4; 3.5; 3.6; 3.7; 3.8; 3.9; 4; 4.1; 4.2; 4.3; 4.4; 4.5; 4.6; 4.7; 4.8; 4.9; 5; 5.1; 5.2; 5.3; 5.4; 5.5; 5.6; 5.7; 5.8; 5.9; 6; 6.1; 6.2; 6.3; 6.4; 6.5; 6.6; 6.7; 6.8; 6.9; 7; 7.1; 7.2; 7.3; 7.4; 7.5; 7.6; 7.7; 7.8; 7.9; 8; 8.1; 8.2; 8.3; 8.4; 8.5; 8.6; 8.7; 8.8; 8.9; 9; 9.1; 9.2; 9.3; 9.4; 9.5; 9.6; 9.7; 9.8; 9.9 and 10.

The use of the singular includes the plural and plural encompasses singular, unless specifically stated otherwise. In addition, the use of “or” means “and/or” unless specifically stated otherwise, even though “and/or” may be explicitly used in certain instances.

“Polymer” generally refers to prepolymers, homopolymers, and copolymers (e.g. block copolymers, terpolymers, etc.) and combinations thereof.

“Acrylamide” or “acrylic amide” refers to a monomer generally comprising the formula CH₂═CHC(O)NH₂, or a polymer generally comprising the formula (—CH₂CHCONH₂—)ₙ.

“Hydrazide” refers to a compound comprising the formula RNHNH₂.

“Crosslinking agent” refers to a compound configured to crosslink with another compound, and typically comprises a monomer and/or polymer.

“Manganese oxide” refers to a compound comprising the formula MnₓO_{y} and optionally hydroxides, such as Mn(II)O, Mn(IV)O₂, Mn(III)₂O₃, Mn(II,III)₃O₄, and Mn(III)OOH.

“Reactive manganese oxide” refers to a manganese oxide of the formula MnO₂, Mn₂O₃, Mn₃O₄, or MnOOH, and combinations thereof.

### II. Colorants

As described above, the present disclosure relates to colorants, as well as coating compositions that comprise a base composition and a colorant. The colorant comprises a pigment with a low level of reactive manganese oxides.

A colorant is generally any color-imparting composition. Colorants may be defined, in part, by their CIELAB color space. In this system, three values are ascribed to a color, with the three values defined as “opponent colors”-black and white; red and green; and blue and yellow. Each opponent color set is assigned an axis: L* indicates lightness and is assigned a value of 0 to 100, with black being 0 and white being 100; a* indicates a value on the red-green axis on which a positive value is towards red and a negative value is towards green; and b* indicates a value on the blue-yellow axis on which a negative value is towards blue and a positive value is towards yellow.

The pigments of the present disclosure may occupy the raw umber color space, as further defined below. The color space may be determined by combining the pigment with a base composition, followed by measurement according to the CIEL*a*b*DE* system with difference measurements calculated with CIEDE2000. Using this method, the pigments of the present disclosure, in the raw umber color space, have a value for L* of +26.00 or greater, +27.00 or greater, +28.00 or greater, +29.00 or greater, +30.00 or less, +31.00 or less, +32.00 or less, +33.00 or less, +34.00 or less, or any value or range encompassed by these endpoints. The value for a* is −1.00 or greater, 0.00 or greater, +1.00 or less, +2.00 or less, +3.00 or less, or any value or range encompassed by these endpoints. The value for b* is +1.00 or greater, +2.00 or greater, +3.00 or less, +4.00 or less, +5.00 or less, or any value or range encompassed by these endpoints.

The colorants of the present disclosure may be in the form of a solution, a suspension, an emulsion, liquid, powder, or any combination thereof. The colorants comprise at least one pigment or dye, and preferably comprise at least one pigment. The pigment may be completely or nearly insoluble in a solvent, such as water. The pigment may be selected from the group consisting of organic, inorganic, color-imparting, effect-imparting, color- and effect-imparting, Non-limiting examples of pigments include aluminum bronzes, stainless steel bronzes, pearlescent pigments, interference pigments, platelet-shaped effect pigments, iron oxide pigments, liquid-crystalline effect pigments, cadmium pigments, chromium pigments, cobalt pigments, copper pigments, iron oxide pigments, lead pigments, manganese pigments, mercury pigments, titanium pigments, zinc pigments, aluminum pigments, carbon pigments, ultramarine pigments, alizarin, gamboge, cochineal red, indigo, Tyrian purple, magenta, phthalo green, phthalo blue, quinacridone, diarylide yellow, umber, raw umber, burnt umber, and combinations thereof. In particular, the pigment may comprise sienna and carbon black.

The pigment may be in the form of a powder or grains, and may have an average particle size of at least 0.1 μm, at least 0.5 μm, at least 1 μm, at least 5 μm, at least 10 μm, at least 20 μm, at least 30 μm, at least 40 μm, at least 50 μm, or any range including any two of these values as endpoints. Stated differently, the pigment may have an average particle size of less than 50 μm, less than 40 μm, less than 30 μm, less than 20 μm, less than 10 μm, less than 5 μm, less than 1 μm, less than 0.5 μm, less than 0.1 μm, or any range including any two of these values as endpoints.

The pigment may be substantially free, essentially free, or completely free of reactive manganese oxides in any or all forms. The term “substantially free” as used in this context indicates that the colorant contains less than 1000 parts per million (ppm), “essentially free” means less than 100 ppm, and “completely free” means less than 20 parts per billion (ppb) of manganese oxide. Stated differently, the pigment may comprise reactive manganese oxides in an atomic percentage (At %) of less than 5 At %, less than 4 At %, less than 3 At %, less than 2 At %, less than 1.5 At %, less than 1 At %, less than 0.5 At %, less than 0.1 At %, less than 0.05 At %, less than 0.01 At %, less than 50 ppm, less than 40 ppm, less than 30 ppm, less than 20 ppm, less than 10 ppm, less than 1 ppm, less than 100 ppb, or any range including any two of these values as endpoints.

The amount and identity of manganese oxide may be determined by X-ray Photoelectron Spectroscopy (XPS). XPS which was used to probe the surface chemical state, composition and homogeneity for all elements detectable on the surface. XPS has a detection limit as low as 0.1 At %, but can be higher depending on the elements found on the surface. Each sample is measured using at least 5 spots to check for homogeneity of composition and chemical state. To measure an individual sample, the pigment powders are mounted onto conductive carbon tape and loaded into a Thermo Scientific K-Alpha X-ray photoelectron spectrometer with a background pressure of 1×10-9 mbar. The K-Alpha is equipped with a monochromatic Al K-alpha excitation source at 1486.7 eV and an Ar+ flood gun for charging compensation. The electron energy calibration is performed with adventitious carbon at 284.8 eV. The XPS spectra are analyzed using CasaXPS1 to determine the surface elemental composition and chemical state components of each element.

The amount of reactive manganese oxide present may refer to the total amount of all forms of reactive manganese oxide, or to the amount of one or more forms of reactive manganese oxide. For example, the colorant may comprise a low amount of manganese (III) oxide, manganese (III) oxyhydroxide, and/or manganese (IV) oxide.

Table 1 below shows the results of elemental analysis comparing the low reactive manganese oxide pigments of the present disclosure in comparison to raw umber pigments. As shown, the low reactive manganese oxide pigments of the present disclosure are substantially free of aluminum, phosphorous, and magnesium, as compared to raw umber pigments.

TABLE 1

| Pigment | Al | C | Ca | Fe | Mg | MnO | Mn₂O₃ | Mn(III)OOH | MnO₂ | O | P | Si |
|---|---|---|---|---|---|---|---|---|---|---|---|---|
| Raw umber | 1.6 | 25.8 | 0.7 | 6.4 | 3.6 | 0.3 | 0.8 | 1.1 | 0.3 | 49.8 | 0.3 | 9.5 |
| pigment | | | | | | | | | | | | |
| Low | 0.0 | 21.1 | 0.2 | 14.4 | 2.0 | — | — | — | — | 56.4 | 0.0 | 5.9 |
| reactive | | | | | | | | | | | | |
| manganese | | | | | | | | | | | | |
| oxide | | | | | | | | | | | | |
| pigment | | | | | | | | | | | | |

The colorant may also comprise a number of additional components, such as, but not limited to, solvents, emulsifiers, inorganic extenders, dispersants, surfactants, dispersing resins, neutralizing agents, and preservatives, for example.

### III. Base Compositions

The colorants described herein may be added to a base composition in order to form a paint or, more generally a coating. The combination of a colorant with a base composition may be referred to as a coating composition, a coating, or a paint. The base composition may comprise a liquid, a suspension, or an emulsion.

The base compositions disclosed herein comprise at least two crosslinking agents, for example a first crosslinking agent and a second crosslinking agent. The crosslinking agents are configured to react and crosslink with one another to form a film or coating. The crosslinking process may not occur until the coating composition is cured or until certain conditions are applied to the composition.

The first crosslinking agent is derived from crosslinkable monomers such as diacetone acrylamide and its derivatives. The second crosslinking agent comprise a compound derived from poly-hydrazide containing functional group —CONHNH₂. Example of the poly-hydrazide includes but not limited to adipic dihydrazide, succinic dihydrazide, citric trihydrazide, isophthalic dihydrazide, phthalic dihydrazide, trimellitic trihydrazide, etc., or any combination thereof.

For example, the first crosslinking agent may comprise an acrylamide and the second crosslinking agent may comprise a hydrazide. More particularly, the first crosslinking agent may comprise diacetone acrylamide (DAAM) and the second crosslinking agent may comprise adipic acid dihydrazide (ADH). The DAAM and ADH may crosslink by reacting the ketone moiety of DAAM with the hydrazide of the ADH through keto-hydrazide crosslinking. Each crosslinking agent may comprise a copolymer. For example, the first crosslinking agent may comprise a DAAM copolymer.

The base composition may comprise a solvent, such as water. The crosslinking agents may not begin to react until the solvent has at least partially evaporated. The evaporation of the solvent may cause the crosslinking agents to coalesce or otherwise come into contact, which may initiate the crosslinking process. The process of crosslinking may also be referred to as curing. Curing may be initiated and/or carried out through heating, evaporation of solvent, application of electromagnetic radiation (e.g. UV, IR, etc.), altering the pH of the composition, addition of a curing agent, addition of a catalyst, or any combination thereof.

### IV. Coating Compositions

Coating compositions may be formed by the combination of a colorant and base composition as described herein. The coating composition may be a paint, sealant, adhesive, topcoat, midcoat, undercoat, primer, or any other suitable coating.

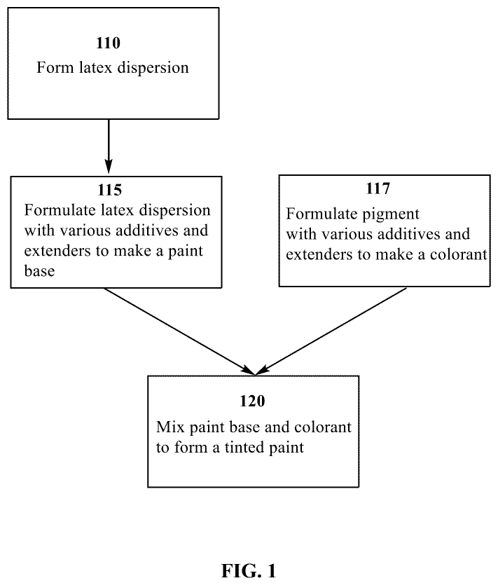

A method for producing a tinted paint is shown in FIG. 1. The method comprises a synthetic step to make a latex dispersion step 110, a formulation step 115 to make a base paint, a formulation step 117 to make a colorant and a mixing step 120 to combine the paint base and the colorant. Synthesis step 110 comprises combining a first crosslinking agent and a second crosslinking agent to form a latex dispersion. The synthesis step 110 may be carried out through any suitable device or system. The formulation step 115 comprises adding a latex dispersion from Step 110 with various components to form the paint base. The formulation step 117 comprises mixing pigment with additives and optionally at least one extender to make a colorant. Formulation step 117 may be performed prior to formulation step 115, after formulation step 115, or at the same time as formulation step 115. Mixing step 120 comprises mixing the paint base and the colorant to form a tinted paint. Multiple colorants may be added. The amount of colorant(s) added may vary depending on the desired color of the final paint, the colorant composition, the base composition, and the desired properties of the final paint. The mixing step 120 may be carried out, for example, in a paint mixer.

The coating composition may be applied to any suitable substrate. Non-limiting examples of substrates include wood, metal, polymers, ceramics, drywall, siding, fabrics, appliances, mechanical parts, automotive parts, structural elements, externally facing elements (e.g. outer walls, supports, etc.), or any combination thereof. The substrate may be pre-treated prior to the application of the coating composition and may comprise a pre-coat or an undercoat. The pretreatment or precoating may improve adhesion of the coating composition to the substrate.

The coating composition may cure at ambient conditions to form a coating. For example, a user may apply the coating composition to a substrate at ambient conditions, a solvent may evaporate from the coating composition, and the crosslinking agents may crosslink to form a film on the substrate. The coating composition may be applied in multiple layers. A given layer of the coating composition or the total thickness of all layers of the coating composition may have a thickness of at least 1 μm, at least 5 μm, at least 10 μm, at least 15 μm, at least 20 μm, at least 30 μm, at least 40 μm, at least 50 μm, at least 60 μm, at least 70 μm, at least 80 μm, at least 90 μm, at least 100 μm, at least 125 μm, at least 150 μm, at least 175 μm, at least 200 μm, or any range including any two of these values as endpoints.

### V. Properties of the Coating Composition

The coating compositions as described herein may reduce the amount of gas generated after the mixing of the colorant with the base composition. For example, a coating composition as described herein may produce less than 2 psi of gas generation in a sealed container with 5% headspace over a period of 30 days at a temperature of 72° F.

Without wishing to be bound to theory, the reduction of manganese oxide in the colorant may reduce the amount of gas generated from the coating composition. In particular, the manganese oxide may react with a hydrazide crosslinking agent to generate a gas, so the reduction of manganese oxide may reduce the amount of gas generated. Particular forms of manganese oxide may be more active and may produce more gas than other forms. For example, Mn₂O₃, MnOOH, and/or MnO₂ may contribute to the generation of gas more than other manganese oxide species.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### EXAMPLES

### Example 1: Color Position of Sienna and Carbon Black Pigment Blend to Represent Raw Umber Color Space

All color values were evaluated using an Xrite Ci7800 benchtop spectrophotometer with Color IQC software, version 10.4.1. The color space measurement systems and difference algorithms used were CIEL*a*b* DE* and Hunter L a b.

The color space was defined for measurement in generic white, medium, and neutral paint formulations in the laboratory using the conditions displayed in the table below.

TABLE 2

| Raw materials | White | Gallons | Medium | Gallons | Neutral | Gallons |
|---|---|---|---|---|---|---|
| Water | 125 | 15.01 | 125 | 15.01 | 125 | 15.01 |
| Natrosol ™ 250 HBR | 0.5 | 0.05 | 1 | 0.10 | 0 | 0.00 |
| Natrosol ™ PLUS 330 | 0 | 0.00 | 0 | 0.00 | 1.5 | 0.15 |
| AMP-95 ™ | 1 | 0.13 | 1 | 0.13 | 1 | 0.13 |
| Tamol ® 165A | 8 | 0.91 | 7 | 0.80 | 6.2 | 0.71 |
| FoamStar ® ST 2412 | 2 | 0.29 | 2 | 0.29 | 2 | 0.29 |
| Hydropalat ® WE3320 | 1 | 0.11 | 1 | 0.11 | 2 | 0.23 |
| Acticide ® BW20 | 4.6 | 0.50 | 4.6 | 0.50 | 4.6 | 0.50 |
| Ti-Pure ™ R-706 | 175 | 5.24 | 100 | 2.99 | 0 | 0.00 |
| Minex ® 3 | 125 | 5.75 | 150 | 6.90 | 200 | 9.20 |
| ASP ® NC X-1 | 25 | 1.16 | 25 | 1.16 | 50 | 2.32 |
| Celite ® 281 | 15 | 0.78 | 20 | 1.04 | 20 | 1.04 |
| Attagel ® 50 | 2 | 0.10 | 4 | 0.20 | 4 | 0.20 |
| Grind for 10-15 minutes, | | | | | | |
| then add: | | | | | | |
| Grind Mixing rpm | 900 | | 1000 | | 1200 | |
| Water | 141.4 | 17.44 | 145.6 | 17.96 | 140.8 | 17.36 |
| FoamStar ® ST 2420 | 2 | 0.28 | 2 | 0.28 | 2 | 0.28 |
| Acronal ® EDGE 4750 | 425 | 48.08 | 425 | 48.08 | 425 | 48.08 |
| Texano ™ | 14 | 1.77 | 14 | 1.77 | 12 | 1.52 |
| Rheovis ® PU 1341 | 16 | 1.83 | 18 | 2.06 | 20 | 2.29 |
| Rheovis ® PU 1251 | 1.3 | 0.15 | 1.8 | 0.21 | 2.5 | 0.29 |
| Acticide ® MKW2 | 4 | 0.41 | 4 | 0.41 | 4 | 0.41 |
| Mix for 15 minutes | | | | | | |
| Letdown mixing rpm | 1200 | | 1200 | | 1200 | |
| Total | 1092 | 99.99 | 1092 | 100.00 | 1092 | 100.00 |
| Used 60 mm diameter | | | | | | |
| Cowles blade, 1 quart | | | | | | |
| container | | | | | | |
| PVC= | 34.97 | | 33.47 | | 34.32 | |
| % DoP | 0.51% | | 0.51% | | 0.49% | |
| Targets | White | | Medium | | Neutral | |
| KU | 95-105 | | 105-110 | | 110-115 | |
| ICI | 1.0-2.0 | | 1.0-2.0 | | 1.0-2.0 | |
| Gloss/Sheen | <5 | | <5 | | <5 | |
| | WB | | MB | | NB | |
| KU | 107.5 | | 109.5 | | 106.4 | |
| ICI | 0.817 | | 0.917 | | 1.092 | |
| Gloss 20, 60, 85 | 1.6, 5.3, 4.2 | | 1.4, 3.9, 2.4 | | 1.2, 3, 1.7 | |

### Example 2: Evaluation Method for Testing Colored Paint

The de-aired density of the colorant was determined by use of a Flacktek DAC 150 SpeedMixer®, or other appropriate method. The volumetric colorant loading into each paint base was calculated based on density: 2 oz/gallon for white (tint) paint base, 10 oz/gallon for medium paint base, 14 oz/gallon for neutral (clear) paint base.

The appropriate amounts of colorant and base were weighed out to the hundredths of a gram and mixed in a speed mixer machine for 60 seconds at 2750 rpm. The tinted paint was then poured onto a sealed Leneta 2C drawdown card in a pool of approximately 1½″ diameter near top of card.

Using a 6 mil bird drawdown bar, the bar was pulled over the length of the card at a consistent rate while applying consistent pressure

The drawdown cared was allowed to flash dry for 15 minutes, then it was placed into a forced air oven at 50° C. (+/−2° C.) per the following: 30 minutes for white (tint) paint base, 30 minutes for medium paint base, 45 minutes for neutral (clear) paint base.

After equilibrating to ambient temperature for 5 minutes, the drawdown card is read on an Xrite Ci7800 or appropriate color measurement spectrophotometer. Use of a color software package with appropriate algorithms, such as Color IQC, or others is necessary to determine the correct color measurement.

### Example 3: Color Values

The color space defined for the Sienna with Carbon Black colored pigment blend in a universal colorant formula with 20-30% pigment loading and milled to a Hegman >7 (<0.5 mil or <13 micron in size) is provided below in Table 3.

TABLE 3

| | |
|---|---|
| CIEL*a*b* | Hunter L a b |

Example 1: Evaluation in Neutral (Clear) Paint Formula

| | | |
|---|---|---|
| a* range | −1.00 to +3.00 | 0.00 to +4.00 |
| b* range | +1.00 to +5.00 | +3.00 to +7.00 |
| L* range | +26.00 to +34.00 | +35.00 to +45.00 |

Example 2: Evaluation in Medium Paint Formula

| | | |
|---|---|---|
| a* range | 0.00 to +4.50 | 0.00 to +4.00 |
| b* range | +6.00 to +9.00 | +4.00 to +8.00 |
| L* range | +55.00 to +65.00 | +47.00 to +57.00 |

Example 3: Evaluation in White (Tint) Paint Formula

| | | |
|---|---|---|
| a* range | −1.00 to +3.00 | −1.00 to +3.00 |
| b* range | +3.00 to +7.00 | +3.00 to +7.00 |
| L* range | +75.00 to +85.00 | +70.00 to +80.00 |

### Example 4: Gas Generation Comparison

In this example, gas generation or off-gassing was compared between a solution comprising a hydrazide and a standard raw umber pigment, and a solution comprising a hydrazide and a pigment with low reactive manganese oxide levels.

Adipic acid dihydrazide (ADH) was dissolved in water to make a 10% ADH in water solution. The 10% ADH solution was mixed with a colorant comprising either the raw umber pigment or the low reactive manganese oxide pigment, both of which are further described in Table 1 above.

The ADH solution and colorant were mixed at a 1:1 volume ratio. 2 mL of each solution/colorant mixture was then filled into a 5 mL Luer Lock syringe, which was then tied and sealed with a Luer lock cap. The syringe position was recorded initially. The syringes were then stored in an oven at 60° C. overnight, and the syringe position was measured again. If gas was generated, the piston of the syringe would be pushed up. The volume difference before and after the overnight storage was divided by the initial volume to determine a % volume change. The results are summarized in Table 4 below.

TABLE 4

| Colorant | Volume Change (%) |
|---|---|
| ADH and normal raw umber colorant | 50 |
| ADH and low-manganese oxide colorant | <10% |

As shown in the table, the pigment with low levels of manganese oxide generated essentially no gas overnight, whereas the normal pigment generated a significant amount of gas. The ADH and low-manganese oxide colorant trail was run twice, and both trials showed 0% volume change overnight.

### Example 5: Long-Term Gas Generation

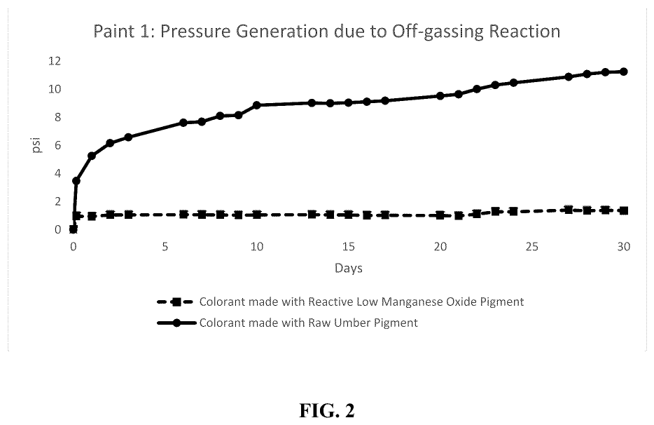

A sealed chamber apparatus was used to study the impact of standard raw umber pigment and a pigment with low reactive manganese oxide levels in paint on gas generation. Both 1 quart and 1 gallon sized sealed chamber were designed such that air could not leak in or out of the chambers and the headspace pressure was monitored over time. The chambers were filled with an ADH containing paint that was subsequently mixed with a colorant to 95% total volume of the chamber, leaving the remaining ambient pressure headspace. The containers were sealed, and the headspace pressure measured every day for 30 days at 72° F. Seven ADH-containing paints were tested using either raw umber or the low reactive manganese oxide pigments of the present disclosure. The results are shown in FIGS. 2-8.

FIG. 2 shows results of a long-term gas generation experiment in a commercially available deep base paint (Paint 1 in FIG. 2) with both ADH and colorants comprising either raw umber or a low reactive manganese oxide pigment. After 30 days, the sample with low reactive manganese oxide pigment displayed less than 2 psi gas generation while the standard raw umber pigment in the same paint generated nearly 12 psi of head space pressure.

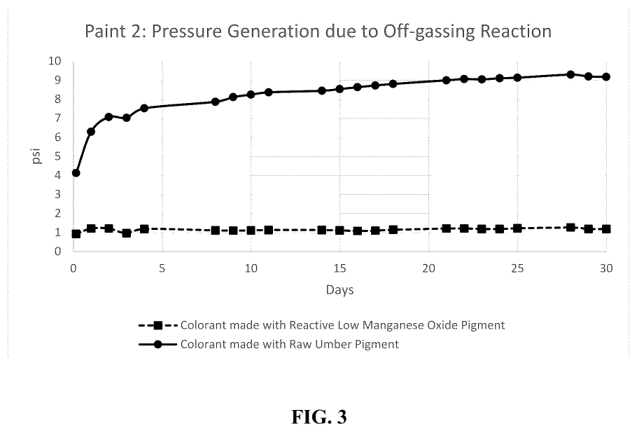

FIG. 3 shows results of a long-term gas generation experiment in an experimental semi-gloss deep base paint containing an experimental latex with a moderate level of ADH (Paint 2 in FIG. 3). The paint was tinted with colorants comprising either raw umber or a low reactive manganese oxide pigment. After 30 days, the sample with low reactive manganese oxide pigment displayed less than 2 psi gas generation while the standard raw umber pigment in the same paint generated roughly 9 psi of head space pressure.

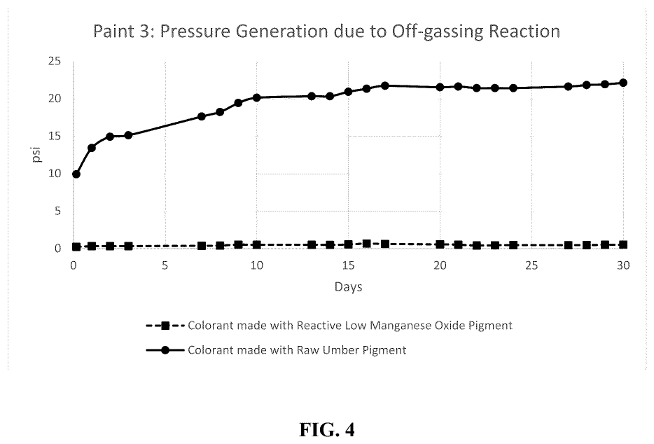

FIG. 4 shows results of a long-term gas generation experiment in an experimental high gloss deep base paint containing an experimental latex with a high level of ADH (Paint 3 in FIG. 4). The paint was tinted with colorants comprising either raw umber or a low reactive manganese oxide pigment. After 30 days, the sample with low reactive manganese oxide pigment displayed less than 2 psi gas generation while the standard raw umber pigment in the same paint generated over 20 psi of head space pressure.

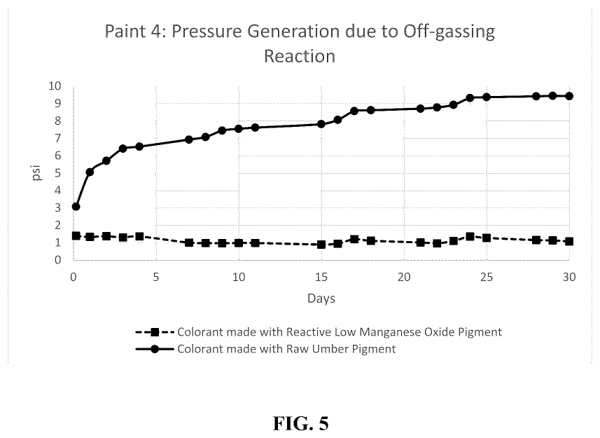

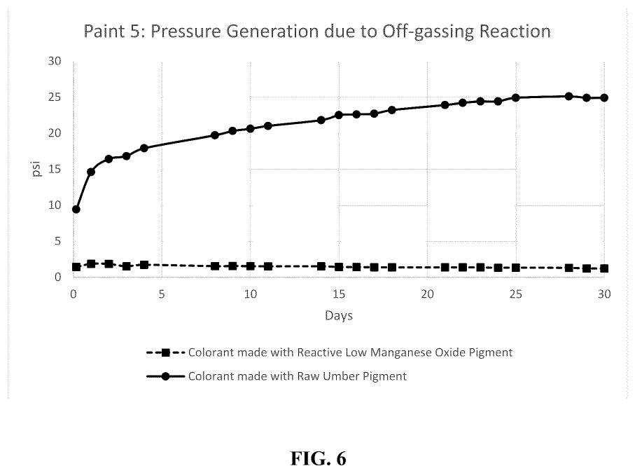

FIG. 5 shows results of a long-term gas generation experiment in an experimental semi-gloss deep base paint containing an experimental latex with a moderate level of ADH (Paint 4 in FIG. 5). The paint was tinted with colorants comprising either raw umber or a low reactive manganese oxide pigment. After 30 days, the sample with low reactive manganese oxide pigment displayed less than 2 psi gas generation while the standard raw umber pigment in the same paint generated nearly 10 psi of head space pressure.

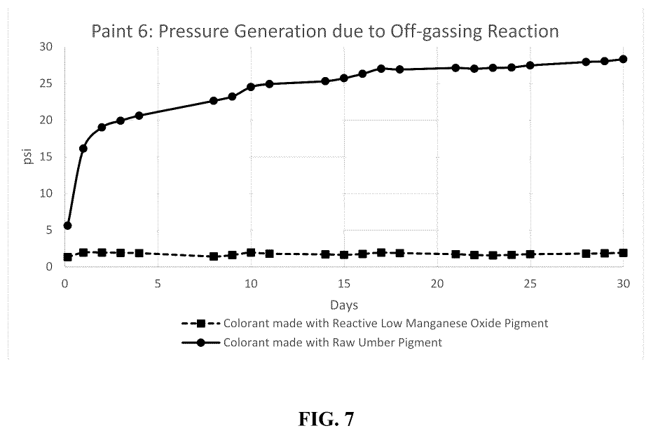

FIG. 6 shows results of a long-term gas generation experiment in an experimental semi-gloss deep base paint containing an experimental latex with a high level of ADH (Paint 5 in FIG. 6). The paint was tinted with colorants comprising either raw umber or a low reactive manganese oxide pigment. After 30 days, the sample with low reactive manganese oxide pigment displayed less than 2 psi gas generation while the standard raw umber pigment in the same paint generated roughly 25 psi of head space pressure.

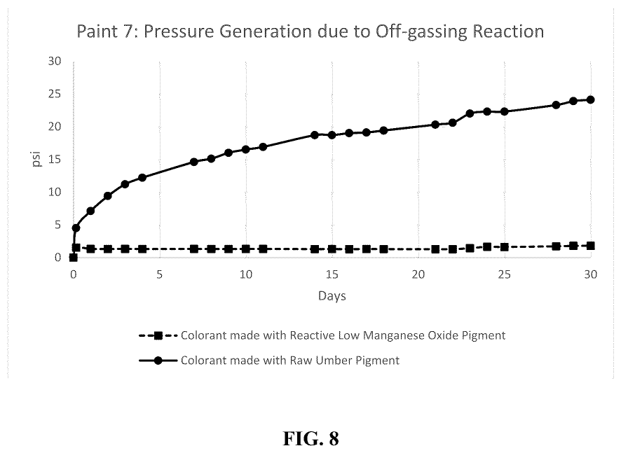

FIG. 7 shows results of a long-term gas generation experiment in an experimental semi-gloss deep base paint containing an experimental latex with a high level of ADH (Paint 6 in FIG. 7). The paint was tinted with colorants comprising either raw umber or a low reactive manganese oxide pigment. After 30 days, the sample with low reactive manganese oxide pigment displayed less than 2 psi gas generation while the standard raw umber pigment in the same paint generated nearly 30 psi of head space pressure.

FIG. 8 shows results of a long-term gas generation experiment in an experimental high gloss deep base paint containing an experimental latex with a high level of ADH (Paint 2 in FIG. 3). The paint was tinted with colorants comprising either raw umber or a low reactive manganese oxide pigment. After 30 days, the sample with low reactive manganese oxide pigment displayed less than 2 psi gas generation while the standard raw umber pigment in the same paint generated roughly 25 psi of head space pressure.

1.-16. (canceled)

17. A pigment, comprising
sienna and/or raw umber pigment,
wherein the color space of a white coating composition with a 2 oz/gallon volumetric colorant loading has the following properties:
(i) L* from +26.00 to +34.00;
a* from −1.00 to +3.00; and
b* from +1.00 to +5.00, as measured using the CIEL*a*b*DE* system;
the color space of a medium coating composition with a 10 oz/gallon volumetric colorant loading has the following properties:
(ii) L* from +55.00 to +65.00;
a* from 0.00 to +4.50; and
b* from +6.00 to +9.00, as measured using the CIEL*a*b*DE* system;
and the color space of a neutral coating composition with a 14 oz/gallon volumetric colorant loading comprising said colorant has the following properties:
(iii) L* from +75.00 to +85.00;
a* from −1.00 to +3.00; and
b* from +3.00 to +7.00, as measured using the CIEL*a*b*DE* system;
wherein an amount of manganese (III) and (IV) oxides in the pigment is less than 0.1 atomic percent (At %) of the pigment.

18. The pigment of claim 17, wherein the pigment comprises sienna.

19. The pigment of claim 17, wherein the pigment further comprises carbon black.

20. A colorant comprising:
the pigment of claim 17;
one or more extenders; and
one or more additives.

21. A paint comprising:
a paint base; and
a colorant comprising:
a pigment comprising sienna and/or raw umber pigment, wherein the color space of a white coating composition with a 2 oz/gallon volumetric colorant loading has the following properties:
(i) L* from +26.00 to +34.00;
a* from −1.00 to +3.00; and
b* from +1.00 to +5.00, as measured using the CIEL*a*b*DE* system;
the color space of a medium coating composition with a 10 oz/gallon volumetric colorant loading has the following properties:
(ii) L* from +55.00 to +65.00;
a* from 0.00 to +4.50; and
b* from +6.00 to +9.00, as measured using the CIEL*a*b*DE* system;
and the color space of a neutral coating composition with a 14 oz/gallon volumetric colorant loading comprising said colorant has the following properties:
(iii) L* from +75.00 to +85.00;
a* from −1.00 to +3.00; and
b* from +3.00 to +7.00, as measured using the CIEL*a*b*DE* system;
wherein an amount of manganese (III) and (IV) oxides in the pigment is less than 0.1 atomic percent (At %) of the pigment.

22. A coating composition comprising:
a first crosslinking agent comprising an acrylamide;
a second crosslinking agent comprising a hydrazide; and
a colorant, comprising:
a pigment; and
one or more additives;
wherein the color space of a white coating composition with a 2 oz/gallon volumetric colorant loading has the following properties:
(i) L* from +26.00 to +34.00;
a* from −1.00 to +3.00; and
b* from +1.00 to +5.00, as measured using the CIEL*a*b*DE* system;
the color space of a medium coating composition with a 10 oz/gallon volumetric colorant loading has the following properties:
(ii) L* from +55.00 to +65.00;
a* from 0.00 to +4.50; and
b* from +6.00 to +9.00, as measured using the CIEL*a*b*DE* system;
and the color space of a neutral coating composition with a 14 oz/gallon volumetric colorant loading comprising said colorant has the following properties:
(iii) L* from +75.00 to +85.00;
a* from −1.00 to +3.00; and
b* from +3.00 to +7.00, as measured using the CIEL*a*b*DE* system;
wherein an amount of manganese (III) and (IV) oxides in the pigment is less than 0.1 atomic percent (At %) of the pigment.

23. The coating composition of claim 17, wherein the colorant comprises sienna.

24. The coating composition of claim 17, wherein the colorant further comprises carbon black.

25. The coating composition of claim 17, wherein the reactive manganese oxide comprises at least one of manganese (III) oxide and manganese (IV) oxide.

26. The coating composition of claim 17, wherein the first crosslinking agent comprises diacetone acrylamide (DAAM).

27. The coating composition of claim 17, wherein the second crosslinking agent comprises adipic acid dihydrazide (ADH).

28. The coating composition of claim 17, wherein the composition with 5% headspace generates less than 2 psi pressure over a period of 30 days at a temperature of 72° F.

29. A method of producing a paint comprising:
combining a first crosslinking agent comprising an acrylamide, a second crosslinking agent comprising a hydrazide, and a solvent to produce a paint base;
combining a pigment and at least one additive to produce a colorant;
adding at least one colorant to the paint base; and
mixing the colorant and the paint base to form a paint, wherein the paint comprises reactive manganese oxide in an amount of less than 0.1 atomic percent (At %) of the pigment; and
wherein the color space of a white coating composition with a 2 oz/gallon volumetric colorant loading has the following properties:
(i) L* from +26.00 to +34.00;
a* from −1.00 to +3.00; and
b* from +1.00 to +5.00, as measured using the CIEL*a*b*DE* system;
the color space of a medium coating composition with a 10 oz/gallon volumetric colorant loading has the following properties:
(ii) L* from +55.00 to +65.00;
a* from 0.00 to +4.50; and
b* from +6.00 to +9.00, as measured using the CIEL*a*b*DE* system;
and the color space of a neutral coating composition with a 14 oz/gallon volumetric colorant loading comprising said colorant has the following properties:
(iii) L* from +75.00 to +85.00;
a* from −1.00 to +3.00; and
b* from +3.00 to +7.00, as measured using the CIEL*a*b*DE* system;
wherein an amount of manganese (III) and (IV) oxides in the pigment is less than 0.1 atomic percent (At %) of the pigment.

30. The method of claim 29, wherein the at least one colorant comprises sienna.

31. The method of claim 29, wherein the at least one colorant further comprises carbon black.

32. The method of claim 29, further comprising the steps of sealing the paint within a container, and storing the paint for a period of 30 days at a temperature of 72° F., wherein during the storing step the paint produces less than 2 psi pressure within the container.
